(19) United States
(12) Patent Application Publication
(10) Pub. No.: US 2020/0096721 A1
(43) Pub. Date: Mar. 26, 2020

(54) OPTICAL BREADBOARD TABLE AND METHOD

(71) Applicant: James Fisher, Tustin, CA (US)

(72) Inventor: James Fisher, Tustin, CA (US)

(21) Appl. No.: 16/431,616

(22) Filed: Jun. 4, 2019

Related U.S. Application Data
(60) Provisional application No. 62/680,141, filed on Jun. 4, 2018.

(51) Int. Cl. G02B 7/00; F16M 11/04; G01M 11/04

(52) U.S. Cl. CPC G02B 7/008; G01M 11/04; F16M 11/04

(57) ABSTRACT

A composite structure includes a top skin defining a plurality of clearance apertures, a core and a bottom skin together with a fastening layer interposed between the top skin and the upper surface of the core. The fastening layer defines a plurality of threaded apertures in alignment and registration with the plurality of clearance apertures formed in the top skin. The threaded apertures each define a threaded aperture size which facilitates threaded fasteners being passed through the clearance apertures of the top skin to threadably engage the threaded apertures of the fastening layer. The top skin, fastening layer, core and bottom skin are joined by conventional attachment such as adhesive attachment, welding or the like.

### CROSS-REFERENCE TO RELATED APPLICATION

This application claims the benefit of and priority under 35 U.S.C. 119(e) of U.S. Provisional Patent Application No. 62/680,141 entitled OPTICAL BREADBOARD TABLE AND METHOD, filed Jun. 4, 2018 in the name of James Fisher, the disclosure of which is incorporated herein by reference.

### FIELD OF THE INVENTION

This invention relates generally to optical breadboards, optical tables and similar structures and particularly to apparatus and methods utilized therein for facilitating the use of threaded fasteners to removably secure a plurality of optical and mechanical components to the table for purposes of study, experiment and production.

### BACKGROUND OF THE INVENTION

Optical breadboards, tables and similar structures of the type toward which the present invention is directed are prevalent within the fields of optical sciences, studies and experimentation. Other fields of scientific endeavor also frequently find use for optical breadboard, optical tables or similar structures. While a virtually endless variety of fabrications have been provided by practitioners in the art in attempting to produce an improved and more effective optical table design, virtually all designs utilize variations of a basic structure provided by a top skin which typically comprises a thin layer or panel of high quality metal such as stainless steel or the like, a core or honeycomb structure of substantially greater thickness than the top skin, and a bottom skin which also typically comprises a thin layer or panel of a metal material. The top skin and bottom skin are joined to the top and bottom surfaces of the core respectively, usually by adhesive attachment, to form a “sandwich” structure.

For the most part, the high quality top skin is intended to provide an extremely smooth, flat uniform surface and usually defines a plurality of threaded apertures which receive threaded fasteners used to secure the various optical and mechanical components and elements to the optical breadboard, table or structure. The qualities sought to be provided by the top skin are precise flat surface, resistance to corrosion, and high strength together with sufficient thickness to allow drilling and tapping.

The core, which is often a honeycomb structure, may be fabricated of a number of materials including ceramics, aluminum alloy, steel or a plastic material. The material selected is typically influenced by the balance of light weight and rigidity.

Generally, the bottom skin is not subject the stringent quality requirements of the top skin and may simply comprise a thin metal panel formed of steel or the like. Additional side, front and rear panels are also often included in the optical breadboard, table or structure to seal the core from liquids and the environment.

The operating environment in which such optical breadboard, optical tables or similar structures are utilized imposes high demands for precision, repeatability and reliability of the experimentation or process carried forward thereon. These demands, in turn, expose problems in many typical optical table designs. For example, the core structures are often ineffective in minimizing and absorbing the effects and transfer of vibrations. Other problems arise due to liquid contamination of the core materials in the event the top surface is exposed to liquid which runs downwardly through the threaded apertures of the top skin into the core. A significant problem arises due to temperature effects as the ambient temperature surrounding the optical breadboard, table or similar structure produces thermal strain (expansion or contraction) of the table material which, in turn, alters and compromises the precision of component placement and spatial distance on those components affixed to the outer surface.

The continuing need for ever more improved optical breadboard, optical tables or similar structures has prompted practitioners in the art to explore a variety of different design. For example, U.S. Pat. No. 8,303,313 issued to Schlossmacher et al entitled BREADBOARD FOR MOUNTING COMPONENTS sets forth an optical table top having a top and bottom skin separated by a plurality of spacers. The top skin supports a plurality of female fasteners secured to the top surface of the top skin and extending downwardly through apertures formed in the top skin into the spacers.

U.S. Pat. No. 5,500,269 issued to Terry entitled HONEYCOMB TABLE MANUFACTURE AND CLEAN-ROOM COMPATIBLE HONEYCOMB TABLES sets forth a table top having a top and bottom skin joined to a honeycomb core. The top skin defines a plurality of threaded apertures and a sealing sheet operative to catch debris and contamination falling into the threaded apertures which would otherwise contaminate the core.

U.S. Pat. No. 4,645,171 issued to Heide entitled HONEYCOMB TABLETOP sets forth a honeycomb tabletop having top and bottom skins supported by a honeycomb core. The top skin defines a plurality of threaded apertures. A plurality of debris catching cups having generally cylindrical shapes are supported within the core each in alignment with one of the threaded apertures. The cups define closed bottom ends and open upper ends and are effective to catch debris falling through the threaded apertures.

U.S. Pat. No. 5,962,104 issued to Gertel et al entitled OPTICAL TABLE sets forth an optical table having a top facing sheet defining a plurality of threaded apertures therein. The table also includes a core and a bottom sheet together with a debris catching panel supported beneath the threaded apertures of the top facing sheet. The debris catching panel defines a plurality of vertical ribs extending upwardly toward and joined to the undersurface of the top facing sheet together with horizontally extending debris catching surfaces at the lower ends of the ribs.

A number of additional devices have been created in the continuing efforts to improve optical breadboard, optical tables or similar structures and particularly the tabletops thereof. However, while the prior art efforts have to some extent improved the art and have in some instances enjoyed commercial success, there remains nonetheless a continuing need in the art for improved optical breadboard, optical tables or similar structures that exhibit resistance to vibrations, an extremely precise and flat top surface, resistance to corrosive chemicals, secure attachment of components, minimum thermal strain in response to ambient temperature variations, strength and rigidity together with reasonably manageable weight.

### SUMMARY OF THE INVENTION

Accordingly, it is a general object of the present invention to provide an improved optical breadboard, optical table or similar structure and method therefore which exhibit resistance to and damping of vibrations. It is a more particular object of the present invention to provide an improved optical breadboard, optical table or similar structure and method which creates an extremely precise and flat top surface for experimentation, production and study. It is a still more particular object of the present invention to provide an improved optical breadboard, optical table or similar structure and method by which contamination of the table top core due to corrosive chemicals is prevented. It is a still more particular object of the present invention to provide an improved optical breadboard, optical table or similar structure and method which increases the security of attachment of scientific components and apparatus. It is a further object of the present invention to provide an improved optical breadboard, optical table or similar structure that facilitates the minimization of thermal strain within the table top in response to ambient temperature variations. Finally, it is an object of the present invention to provide the foregoing improvements while simultaneously addressing the continuing need for strength and rigidity together with reasonably manageable weight in such optical breadboard, optical tables or similar structures.

The present invention provides an improved optical breadboard, optical table or similar structure and method in which a composite structure includes a top skin defining a plurality of clearance apertures, a core and a bottom skin together with a fastening layer interposed between the top skin and the upper surface of the core. The fastening layer defines a plurality of threaded apertures in alignment and registration with the plurality of clearance apertures formed in the top skin. The threaded apertures each define a threaded aperture size which facilitates threaded fasteners being passed through the clearance apertures of the top skin to threadably engage the threaded apertures of the fastening layer. The top skin, fastening layer, core and bottom skin are joined by conventional attachment such as adhesive attachment, welding or the like.

While the present invention is often set forth herein in the context of a top surface fastening layer and top skin, it will be understood that the present invention is not limited to enhancement of the top surface of a breadboard or table top. It will be further understood that the present invention combination of a fastening layer upon which an outer skin has been secured may also provide for aperture side skins, end skins and bottom skins all supported by respective fastening layers which in turn are joined to the respective sides, ends and bottom of the core.

From another perspective, the present invention provides an optical breadboard table comprising: a core defining a core upper surface; a fastening layer defining a fastening layer upper surface and a fastening layer bottom surface and a plurality of spaced apart threaded fastening apertures, each defining a threaded diameter, the threaded fastening apertures being arranged in a pre-determined pattern, the fastening layer bottom surface being joined to the core upper surface; a top skin defining a top skin upper surface and a top skin bottom surface and a plurality of spaced apart clearance apertures, each defining a clearance diameter greater than the threaded diameters, the clearance apertures being arranged in the pre-determined pattern and in registry with the threaded fastening apertures, the top skin bottom surface being joined to the fastening layer upper surface, whereby optical apparatus may be positioned upon the top skin upper surface and secured thereon by a plurality of threaded fasteners passing through selected ones of the clearance apertures and threadably engaging underlying ones of the plurality of threaded fastening apertures such that attachment stress upon the top skin is minimized.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a table top utilized in the optical breadboard table and method of the present invention;

FIG. 2 sets forth a perspective exploded view of the tabletop shown in FIG. 2;

FIG. 3 sets forth a perspective view of a fastening layer constructed in accordance with the present invention;

FIG. 4 sets forth a top view of the fastening layer shown in FIG. 3;

FIG. 5 sets forth an end view of the fastening layer shown in FIG. 3;

FIG. 6 sets forth a section view of the fastening layer shown in FIG. 5 taken along section lines 6-6 therein;

FIG. 7 sets forth a perspective view of an alternate embodiment fastening layer of the present invention optical breadboard table;

FIG. 8 sets forth a partial section view of the fastening layer set forth in FIG. 7 taken along section lines 8-8 therein;

FIG. 9 sets forth a perspective assembly view of a further alternate embodiment fastening layer of the present invention optical breadboard table;

FIG. 10 sets forth a partial section view of a portion of the fastening layer set forth in FIG. 9 taken along section lines 10-10 therein; and

FIG. 11 sets forth a partial section view of a portion of the fastening layer set forth in FIG. 9 taken along section lines 11-11 therein.

### DESCRIPTION OF THE PREFERRED EMBODIMENTS OF THE INVENTION

By way of overview, the present invention provides an improved optical breadboard table and method in which a table top having a top skin defining a plurality of clearance apertures, a core and a bottom skin is improved by adding a fastening layer interposed between the top skin and the upper surface of the core. The fastening layer defines a plurality of threaded apertures in alignment and registration with the plurality of clearance apertures formed in the top skin. The threaded apertures are each sized to facilitate the insertion of threaded fasteners through the clearance apertures of the top skin to threadably engage the threaded apertures of the fastening layer. In this manner, the thickness of the top skin may be substantially reduced, or comprised of composite material, because the need for forming threads within the top skin apertures is avoided. The top skin, fastening layer, core and bottom skin are joined by conventional attachment such as adhesive attachment, welding or the like.

While the present invention is often set forth herein in the context of a top surface fastening layer and top skin, it will be understood that the present invention is not limited to enhancement of the top surface of a breadboard or table top. It will be further understood that the present invention combination of a fastening layer upon which an outer skin has been secured may also provide for aperture side skins, end skins and bottom skins all supported by respective fastening layers which in turn are joined to the respective sides, ends and bottom of the core.

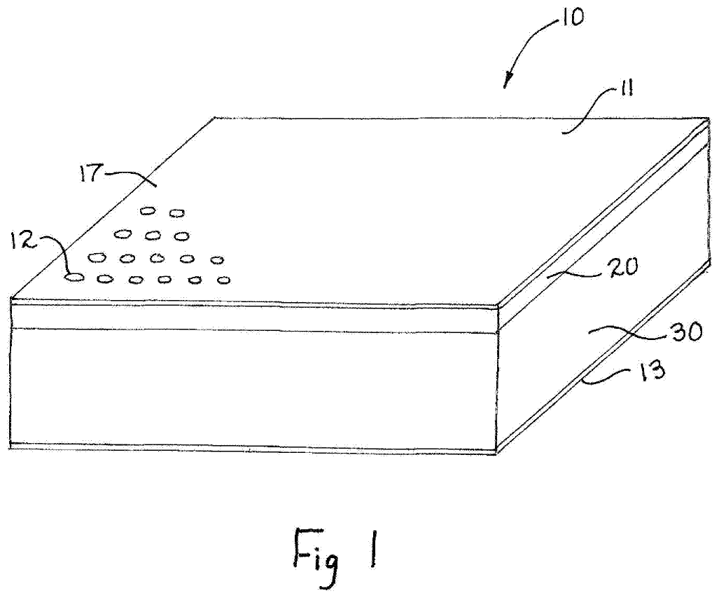

More specifically, FIG. 1 sets forth a perspective view of a table top utilized in the optical breadboard table and method of the present invention generally referenced by numeral 10. Tabletop 10 is formed of a plurality of layers in a “sandwich” structure that includes a core 30 having a bottom skin 13 bonded to the lower surface thereof and a fastening layer 20 bonded to the upper surface of core 30. The structure is completed by a top skin 11 bonded to the upper surface of fastening layer 20. In accordance with an important aspect of the present invention described below in greater detail, top skin 11 defines a plurality of clearance apertures 12.

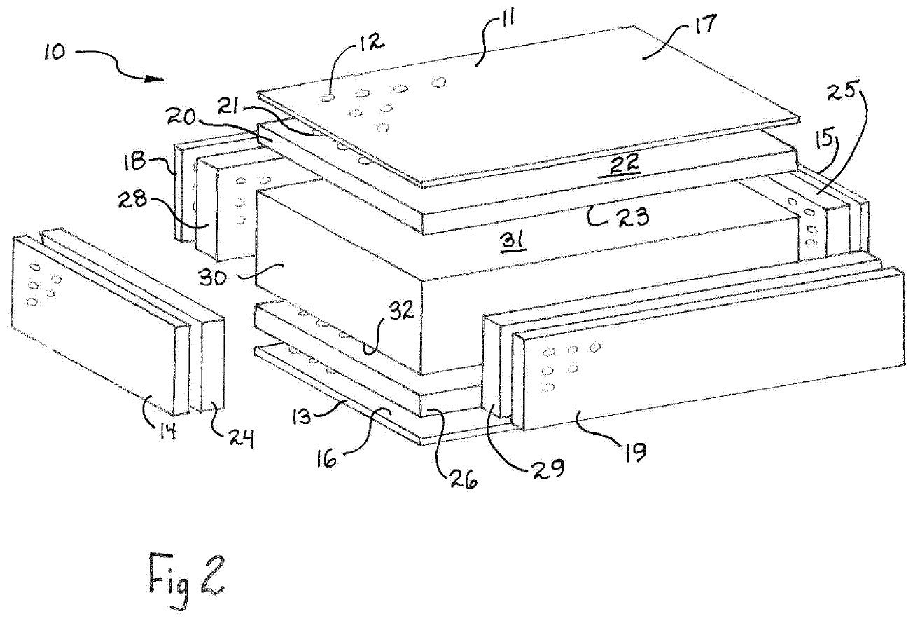

FIG. 2 sets forth an exploded view of tabletop 10. As described above, tabletop 10 includes a plurality of layers in a stacked arrangement which include a top skin 11, a fastening layer 20, a core 30 and a bottom skin 13 mutually bonded to form a sandwich-like structure. Top skin 11 defines a plurality of clearance apertures 12 and is preferably formed of a high quality material, such as stainless steel or composite material. Top skin 11 defines an extremely flat high precision upper surface 17. In accordance with an important aspect of the present invention, tabletop 10 further includes a fastening layer 20 positioned beneath top skin 11. Fastening layer 20 is joined to top skin 11 by a conventional attachment process such as adhesive bonding, or the like. Fastening layer 20 defines an upper surface 22 and a bottom surface 23. Fastening layer 20 further defines a plurality of threaded apertures 21 arranged in the same spatial order as apertures 12 of top skin 11. Additionally, the attachment of fastening layer 20 to top skin 11 is carried forward in a manner providing accurate registration between threaded apertures 21 of fastening layer 20 and clearance apertures 12 of top skin 11. As a result, each of clearance apertures 12 of top skin 11 is aligned with a corresponding threaded aperture 21 formed in fastening layer 20. In the preferred fabrication of the present invention, fastening layer 20 is formed of a suitable material such as aluminum, steel or the like. As is set forth below in greater detail, and in accordance with the present invention, fastening layer 20 may be fabricated in accordance with one of the several embodiments set forth below to provide the basic function of supporting a plurality of threaded apertures in registration and alignment with clearance apertures 12 of top skin 11. The structure of tabletop 10 is completed by a pair of side skins 14 and 15.

Tabletop 10 further includes a core 30 which defines an upper surface 31 and a lower surface 32. Upper surface 31 of core 30 is bonded to undersurface 23 of fastening layer 20 utilizing conventional attachment processes such as adhesive attachment, or the like. Core 30 may be formed as a honeycomb structure or, alternatively, may be a solid structure formed of a material such as aluminum, ceramic, or the like. Tabletop 10 further includes a bottom skin 13 having an upper surface 16. Bottom skin 13 is preferably fabricated of a metal material such as steel, composite or the like. Upper surface 16 of bottom skin 13 is bonded to bottom surface 32 of core 30 by conventional attachment such as adhesive bonding, or the like.

While the combination of top skin 11, fastening layer 20, core 30 and bottom skin 13 forms a complete tabletop, it has been found advantageous to provide additional component attachments for tabletop 10 by adding end skins 14 and 15 at each end of the table top. To provide further component attachment capability, side skins 18 and 19 together with bottom skin 13 are also added. In further accordance with the present invention corresponding fastening layers are provided for supporting end skins 14 and 15, side skins 18 and 19, and bottom skin 13 in the form of fastening layers 24 and 25, 28 and 29, and 26 respectively. With the additional end, side and bottom apertured skins together with their, respective apertured fastening layers, all six surfaces of a breadboard or table top may be utilized.

Once tabletop 10 has been fabricated, it provides an extremely precise flat upper surface 17 upon which various optical or mechanical components may be secured using threaded fasteners (not shown) that are passed through clearance apertures 12 of top skin 11 and are received in threaded engagement within threaded apertures 21 of fastening layer 20. In accordance with an important advantage of the present invention, it will be noted that top skin 11 does not define threaded apertures in the manner of the prior art structures. Instead, top skin 11 defines unthreaded clearance apertures. The absence of threads within clearance apertures 12 of top skin 11 ensures that top skin 11 is not required to absorb and sustain the stresses imposed by tightened fasteners. In a further advantage of the present invention, the absence of threads within clearance apertures 12 of top skin 11 facilitates the fabrication of tabletop 10 using a significantly thinner metal or composite material panel for top skin 11. This provides a cost savings and a reduction in the overall weight of the table top. More importantly however, the use of threaded apertures within fastening layer 20 and the avoiding of imposing stress upon top skin 11 helps maintain the flat precision thereof.

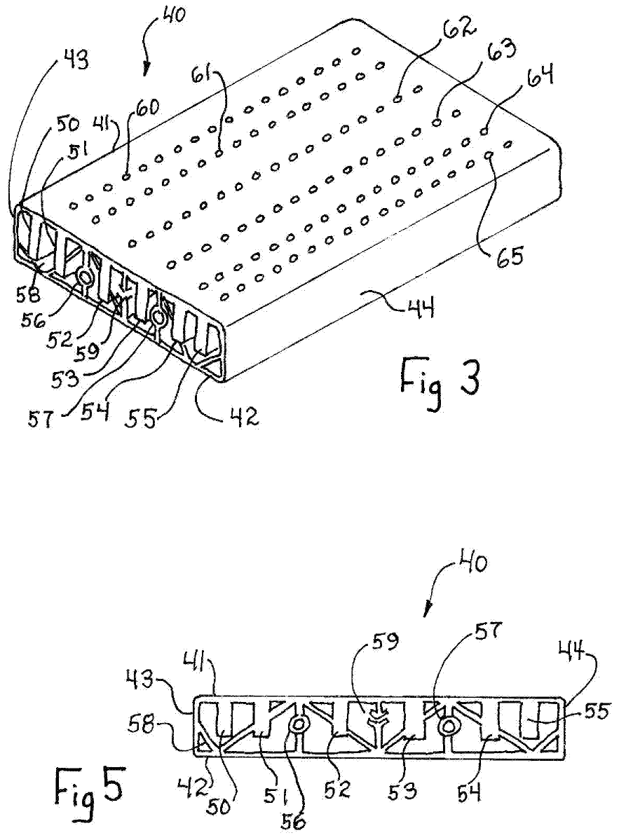

FIG. 3 sets forth a perspective view of an extruded fastening layer constructed in accordance with the present invention and generally referenced by numeral 40. Fastening layer 40 is fabricated using an extrusion process which has the advantage of producing components having virtually any desired length. In essence, the extrusion process facilitates manufacture in which components are extruded and thereafter cut to the desired length. As can be seen in FIG. 3, the resulting extruded component provides a unitary element having top, bottom and sides integrally formed as a single unit. Thus, fastening layer 40 includes a top surface 41, a bottom surface 42, a side surface 43 and a side surface 40. Within the interior of fastening layer 40 a plurality of parallel ribs 50 through 55 extend downwardly from the underside of top surface 41. Ribs 50 through 55 provide the material within which a plurality of threaded apertures (seen in FIG. 6) are formed. Accordingly, a row of threaded apertures 60 is formed in top surface 41 and rib 50. Similarly, a row of threaded apertures 61 is formed in top surface 41 and rib 51. In the same manner, a row of threaded apertures 62 is formed in top surface 41 and rib 52 while a row of threaded apertures 63 is formed in top surface 41 and rib 53. Finally, a row of threaded apertures 64 is formed in top surface 41 and rib 54 while a row of threaded apertures 65 is formed in top surface 41 and rib 55. A plurality of angled support ribs such as angled support rib 58 extend between the side, top and bottom surfaces of fastening layer 42 provide strength and rigidity of the structure. In addition, a vibration damping element 59 a material, such as an elastomer, is formed between top surface 41 and bottom surface 42. A pair of elongated passages 56 and 57 extending the length of fastening layer 40 and are available for use as either connecting wire conduits or as passages for liquid coolant to be pumped through fastening layer 42 thermally stabilize the fastening layer.

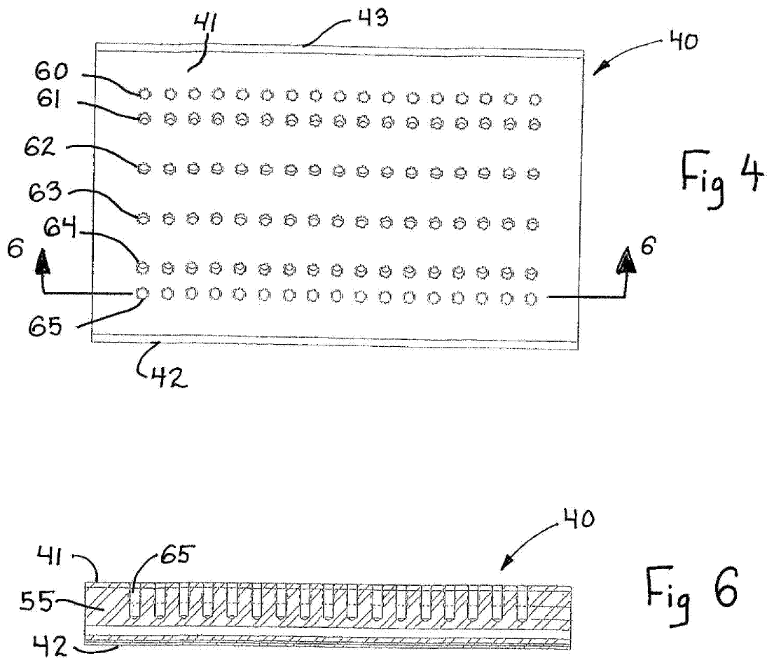

FIG. 4 sets forth a top view of fastening layer 40 showing top surface 41 together with side 42 and 43. As described above fastening layer 40 defines a plurality of threaded aperture rows 60 through 65 which it will be recalled extend downwardly into ribs 50 through 55 (seen in FIG. 3) respectively. It will be apparent to those skilled in the art that the pattern and arrangement of threaded apertures formed in fastening layer 40 is provided for purposes of illustration and not limitation. It will be equally apparent to those skilled in the art that a virtually endless variety of patterns and arrangements of threaded apertures, support ribs damping elements or elongated passages may be utilized in fastening layer 40 without departing from the spirit and scope of the present invention. The important aspect when considering the arrangement and pattern of threaded apertures formed in fastening layer 40 is the anticipated locations upon the top surface of the resulting optical breadboard table which will be desired in the eventual use of the optical breadboard table. Also, it will be recalled that the clearance apertures, such as clearance apertures 12 formed in top skin 11, (seen in FIG. 1) will correspond to the pattern and arrangement of threaded apertures formed in fastening layer 40.

FIG. 5 sets forth an end view of fastening layer 40. As described above, fastening layer 40 includes a top surface 41, a bottom surface 42, a side surface 43 and a side surface 40. Within the interior of fastening layer 40 a plurality of parallel ribs 50 through 55 extend downwardly from the underside of top surface 41. As is also mentioned above, ribs 50 through 55 provide the material within which a plurality of threaded apertures (seen in FIG. 6) are formed. A plurality of angled support ribs, such as angled support rib 58, extend between the side, top and bottom surfaces of fastening layer 42 provide strength and rigidity of the structure. In addition, a vibration damping element 59 is formed between top surface 41 and bottom surface 42. A pair of elongated passages 56 and 57 extending the length of fastening layer 40 and are available for use as either connecting wire conduits or as passages for liquid coolant to be pumped through fastening layer 42 thermally stabilize the fastening layer.

FIG. 6 sets forth a section view of fastening layer 40 taken along section lines 6-6 in FIG. 4. As described above fastening layer 40 includes a top surface 41 and a bottom surface 42. Fastening layer 40 includes a rib 55 extending downwardly from the underside of top surface 41. Of importance to note, is the extension of rib 55 or the length of fastening layer 40. A row of threaded apertures 65 extends downwardly through top surface 41 into rib 55. It will be noted that the threaded apertures formed in rib 55 are preferably “closed end” apertures. In accordance with an important aspect of the present invention, the use of closed end threaded apertures 65 provides an additional benefit liquid and other contaminating materials are presented from flowing downwardly through unoccupied threaded apertures into the optical breadboard table core. However, apertures 65 may be through holes where desired for ease of manufacture. It will be recalled that this isolation of contamination from the breadboard core is a highly desirable quality for optical breadboard, optical tables or similar structures.

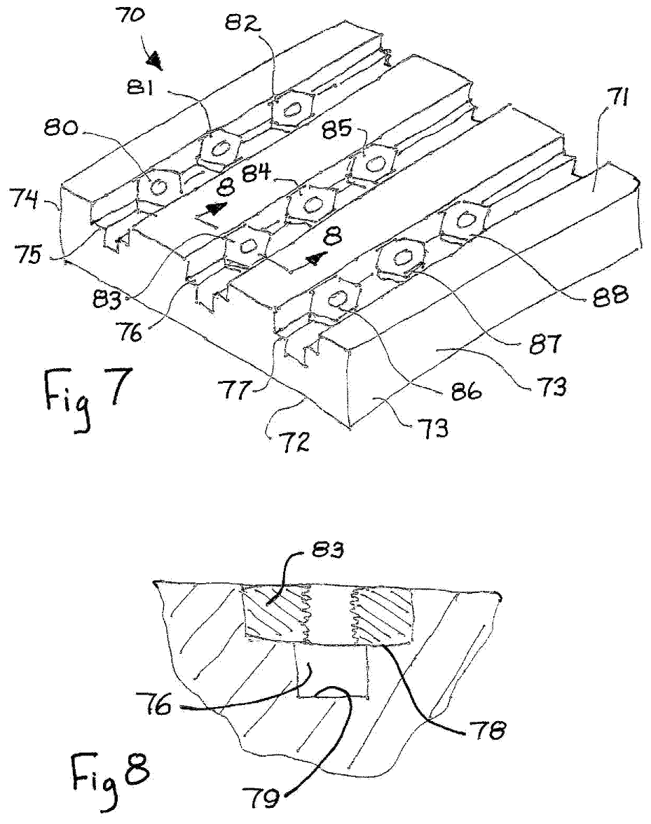

FIG. 7 sets forth a perspective view of an alternate embodiment fastening layer of the present invention optical breadboard table generally referenced by numeral 70. Fastening layer 70 utilizes an extruded, formed or cast element having a plurality of voids formed therein. The material selected for the element may, for example, comprise a suitable metal such as steel, aluminum or the like. Alternatively, the element utilized in forming fastening layer 70 may be fabricated of a composite material or a ceramic material. The essential property required in forming fastening layer 70 is sufficient strength and rigidity to provide a solid firm support for the top skin which it supports in a typical optical breadboard table such as shown above in FIG. 1.

For purposes of illustration, fastening layer 70 is shown in FIG. 7 having three voids formed therein. However, it will be recognized by those skilled in the art that three voids are shown merely for illustration. The more likely fabrication of fastening layer 70 could utilize a substantially different number of voids to support a substantially greater number of threaded apertures to provide a practical optical breadboard table. Accordingly, fastening layer 70 includes a plurality of voids 75, 76 and 77 which extend the length of fastening layer 70. In the preferred fabrication of fastening layer 70, the cross-section shape of voids 75, 76 and 77 is substantially T-shaped. The use of T-shaped void cross-sections provides the capability for using each void as both a threaded fastener support void and a media or wiring void as desired. In essence, the cross portion of the T-shaped void supports a plurality of threaded fasteners while the bottom portion of the T-shaped void forms a media or wiring passage.

A plurality of conventional threaded fasteners 80, 81 and 82 are received within the upper portion of void 75 and secured therein by conventional attachment such as adhesive bonding or welding or mechanical crimping or swagging. Similarly, conventional fasteners 83, 84 and 85 are received and secured within the upper portion of void 76 while fasteners 86, 87 and 88 are received and secured within channel 77.

FIG. 8 sets forth a partial section view of fastening layer 70 taken along section lines 8-8 in FIG. 7. It will be apparent to those skilled in the art that FIG. 8 is equally representative of the assembly and resulting structure provided for the remainder of threaded fasteners utilized in forming fastening layer 70 (seen in FIG. 7). A generally T-shaped void 76 defines an upper portion 78 and a downwardly extending lower portion 79. A threaded fastener 83 which, in its simplest form, comprises a conventional threaded “nut” is received within upper portion 78 of T-shaped void 76. As mentioned above, the position of threaded fastener 83 is secured within void 76 by conventional attachment such as adhesive bonding or welding or mechanical crimping or swagging. Of importance to note in FIG. 8 is the creation of a media passage 79 in the lower portion of T-shaped void 76.

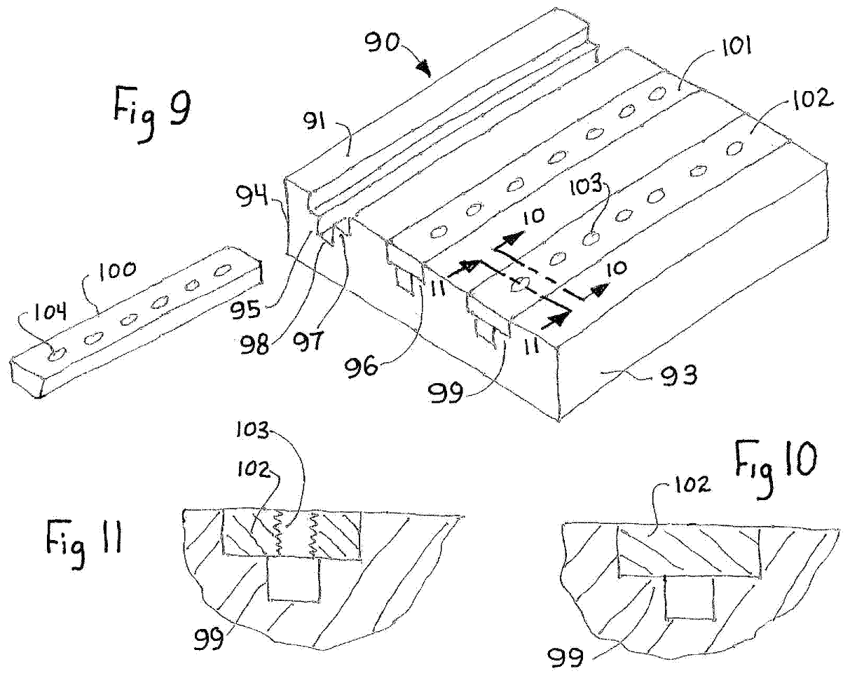

FIG. 9 sets forth a perspective assembly view of a further alternate embodiment fastening layer of the present invention optical breadboard table generally referenced by numeral 90. Fastening layer 90 is substantially identical to fastening layer 70 set forth above with the difference being found in the utilization of an elongated multi-aperture fastener bar in place of a plurality of individual threaded fasteners. Thus, for example as is seen in FIG. 7, void 75 of fastening layer 70 receives individual threaded fasteners 80, 81 and 82. Whereas, as is seen in FIG. 9, void 95 of fastening layer 90 receives elongated fastening bar 100. In all other respects, fastening layer 90 is substantially the same as fastening layer 70 and is similarly formed. Accordingly, fastening layer 90 includes a plurality of voids 95 and 96 which extend the length of fastening layer 90. In the preferred fabrication of fastening layer 90, the cross-section shape of voids 95, and 96 is substantially T-shaped. As mentioned above, the use of T-shaped void cross-sections provides the capability for using each void as both a threaded fastener support void and a media or wiring void as desired. In essence, the cross portion of the T-shaped void supports threaded fastener bar 100 while bottom portion 98 of the T-shaped void forms a media or wiring passage.

An elongated threaded fastener bar 100 defines a plurality of threaded apertures 104 and is received within the upper portion of void 95 and secured therein by conventional attachment such as adhesive bonding or welding or mechanical crimping or swagging. Similarly, elongated threaded fastener bars 101 and 102 are received and secured within the upper portion of voids 96 and 99.

FIG. 10 sets forth a partial section view of a portion of fastening layer 90 taken along section lines 10-10 in FIG. 9. FIG. 10 show a typical portion of fastening layer 90 between threaded apertures within elongated threaded aperture bar 102. Of importance to note is the closure that elongated threaded aperture bar 102 provides for the lower portion of void 99.

FIG. 11 sets forth a partial section view of a portion of fastening layer 90 taken along section lines 11-11 in FIG. 9. FIG. 11 shows a typical portion of fastening layer 90 and a threaded aperture within the elongated threaded aperture bar. Of importance to note is the closure that elongated threaded aperture bar 102 provides for the lower portion of void 99.

What has been shown is an improved optical breadboard table and method in which a table top includes a top skin defining a plurality of clearance apertures, a core and a bottom skin together with a fastening layer interposed between the top skin and the upper surface of the core. The fastening layer defines a plurality of threaded apertures in alignment and registration with the plurality of clearance apertures formed in the top skin. The threaded apertures each define a threaded aperture size which facilitates threaded fasteners being passed through the clearance apertures of the top skin to threadably engage the threaded apertures of the fastening layer. The top skin, fastening layer, core and bottom skin are joined by conventional attachment such, as adhesive attachment, welding or the like.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. An optical breadboard table comprising:
a core defining a core upper surface;
a fastening layer defining a fastening layer upper surface and a fastening layer bottom surface and a plurality of spaced apart threaded fastening apertures, each defining a threaded diameter, said threaded fastening apertures being arranged in a pre-determined pattern, said fastening layer bottom surface being joined to said core upper surface;
a top skin defining a top skin upper surface and a top skin bottom surface and a plurality of spaced apart clearance apertures, each defining a clearance diameter greater than said threaded diameters, said clearance apertures being arranged in said pre-determined pattern and in registry with said threaded fastening apertures, said top skin bottom surface being joined to said fastening layer upper surface,
whereby optical apparatus may be positioned upon said top skin upper surface and secured thereon by a plurality of threaded fasteners passing through selected ones of said clearance apertures and threadably engaging underlying ones of said plurality of threaded fastening apertures such that attachment stress upon said top skin is minimized.

2. The optical breadboard table set forth in claim 1 wherein said core defines a bottom surface, said optical breadboard table further comprising:
a bottom fastening layer defining a bottom fastening layer upper surface and a bottom fastening layer bottom surface and a plurality of spaced apart threaded fastening apertures, each defining a threaded diameter, said threaded fastening apertures being arranged in a pre-determined pattern, said bottom fastening layer bottom surface being joined to said core bottom surface; and
a bottom skin defining a bottom skin upper surface and a bottom skin bottom surface and a plurality of spaced apart clearance apertures, each defining a clearance diameter greater than said threaded diameters, said clearance apertures being arranged in said pre-determined pattern and in registry with said threaded fastening apertures, said bottom skin top surface being joined to said fastening layer bottom surface,
whereby optical apparatus may be positioned upon said bottom skin bottom surface and secured thereon by a plurality of threaded fasteners passing through selected ones of said clearance apertures and threadably engaging underlying ones of said plurality of threaded fastening apertures such that attachment stress upon said bottom skin is minimized.

3. The optical breadboard table set forth in claim 1 wherein said core is formed of a solid material and each of said plurality of threaded fastening apertures is formed as a blind threaded aperture therein.

4. The optical breadboard table set forth in claim 3 wherein said core is formed of a solid material defining a plurality of elongated fastener channels each of said fastener channels supporting a plurality of fasteners at fixed positions therein, said fastener channels each further defining debris receiving voids extending downwardly therefrom.

5. The optical breadboard table set forth in claim 3 wherein said core is formed of a solid material defining a plurality of elongated fastener channels each of said fastener channels further defining debris receiving voids extending downwardly therefrom and a plurality of elongated fastener strips secured within each of said fastener channels, said fastener strips each defining a plurality of threaded fastener apertures.

6. The optical breadboard table set forth in claim 1 wherein said fastening layer is formed of an extruded member defining a cross-sectional shape having an upper surface which in turn supports a plurality of downwardly extending ribs and bottom surface, said fastening layer further including a plurality of threaded fastening apertures extending through said upper surface and into an underlying one of said plurality of downwardly extending ribs.

7. The optical breadboard table set forth in claim 6 wherein said cross-sectional shape of said fastening layer further includes a plurality of angled support ribs extending between said upper surface and said bottom surface.

8. The optical breadboard table set forth in claim 7 wherein said cross-sectional shape of said fastening layer further includes a plurality of vibration dampers extending between said upper surface and said bottom surface.

9. The optical breadboard table set forth in claim 6 wherein said cross-sectional shape of said fastening layer further includes a plurality of coolant carrying passages between said upper surface and said bottom surface.

10. An optical breadboard table comprising:
a core defining a plurality of core surfaces;
a plurality of fastening layers each defining a fastening layer inner surface and a fastening layer outer surface and each defining a plurality of spaced apart threaded fastening apertures, each defining a threaded diameter, said threaded fastening apertures being arranged in pre-determined patterns, said fastening layers each being joined to one of said core surfaces;
a plurality of top skins each defining a top skin outer surface and a top skin inner surface and each defining a plurality of spaced apart clearance apertures, each of said clearance apertures defining a clearance diameter greater than said threaded diameters, said clearance apertures being arranged in said pre-determined pattern and in registry with said threaded fastening apertures, said top skin inner surface being joined to said fastening layer outer surface,
whereby optical apparatus may be positioned upon said top skins outer surfaces and secured thereon by a plurality of threaded fasteners passing through selected ones of said clearance apertures and threadably engaging underlying ones of said plurality of threaded fastening apertures such that attachment stress upon said top skins is minimized.

11. The optical breadboard table set forth in claim 1 wherein said top skin is formed of a metal material.

12. The optical breadboard table set forth in claim 1 wherein said top skin is formed of a composite material.

13. The optical breadboard table set forth in claim 6 wherein said cross-sectional shape of said fastening layer further includes a plurality of passages between said upper surface and said bottom surface suitable for having cables run therethrough.

14. The optical breadboard table set forth in claim 6 wherein said cross-sectional shape of said fastening layer further includes a plurality of passages between said upper surface and said bottom surface suitable for having tubes run therethrough.

15. An optical breadboard table comprising:
a fastening layer defining a fastening layer upper surface and a fastening layer bottom surface and a plurality of spaced apart threaded fastening apertures, each defining a threaded diameter, said threaded fastening apertures being arranged in a pre-determined pattern; and
a top skin defining a top skin upper surface and a top skin bottom surface and a plurality of spaced apart clearance apertures, each defining a clearance diameter greater than said threaded diameters, said clearance apertures being arranged in said pre-determined pattern and in registry with said threaded fastening apertures, said top skin bottom surface being joined to said fastening layer upper surface,
whereby optical apparatus may be positioned upon said top skin upper surface and secured thereon by a plurality of threaded fasteners passing through selected ones of said clearance apertures and threadably engaging underlying ones of said plurality of threaded fastening apertures such that attachment stress upon said top skin is minimized.
